(19) United States
(12) Patent Application Publication
(10) Pub. No.: US 2026/0333011 A1
(43) Pub. Date: Oct. 22, 2026

(54) METHOD AND APPARATUS FOR CONFIGURING LOCATION REPORTING TYPE

(71) Applicant: Telefonaktiebolaget LM Ericsson (publ), Stockholm (SE)

(72) Inventors: Shuai GU, Shanghai (CN); Lei XIA, Shanghai (CN); Xuemei ZHANG, Shanghai (CN); Nianshan SHI, Jarfalla (SE)

(21) Appl. No.: 19/101,481

(22) PCT Filed: Aug. 4, 2023
(86) PCT No.: PCT/CN2023/111316

§ 371 Date: Feb. 5, 2025

(30) Foreign Application Priority Data
Aug. 5, 2022 (WO) PCT/CN2022/110512

(51) Int. Cl. H04W 8/12; H04W 4/021; H04W 64/00; H04W 92/24

(52) U.S. Cl. CPC H04W 8/12; H04W 4/021; H04W 64/00; H04W 92/24

(57) ABSTRACT

Embodiments of the present disclosure provide a method and an apparatus for configuring location reporting type. A method (200) performed by a first network node may comprise receiving (S202) from a second network node, a message indicating a plurality of location reporting request types; and reporting (S204) a location of a terminal device to the second network node, when a location reporting request type in the plurality of location reporting request types is satisfied. By including a plurality of location reporting request types in a message, AMF can configure multiple Location Reporting Request Types at the same time. Therefore, the efficiency may be improved.

### TECHNICAL FIELD

The present disclosure relates generally to the technology of communication network, and in particular, to a method and an apparatus for configuring location reporting type.

### BACKGROUND

This section introduces aspects that may facilitate better understanding of the present disclosure. Accordingly, the statements of this section are to be read in this light and are not to be understood as admissions about what is in the prior art or what is not in the prior art.

In communication network, many technologies are applied to improve the performance.

For example, a location reporting procedure allows an access and mobility management function, AMF, to request a next generation-radio access network node, NG-RAN node, to report the UE (user equipment)'s location, or the UE's presence in the area of interest while in CM (connection management)-CONNECTED state. AMF sends a message including Location Reporting Request Type, to the NG-RAN node. Then, the NG-RAN will report the location, based at least on the location reporting request type.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be different location reporting request types. However, when AMF sends a message including Location Reporting Request Type to the NG-RAN node, only one type is included. For example, according to current communication standards (such as in a 3^{rd} generation partnership project technical specification, 3GPP TS38.413 v17.0.0), when the AMF configures two location reporting request types, the AMF should send two messages.

Certain aspects of the present disclosure and their embodiments may provide solutions to these or other challenges. There are, proposed herein, various embodiments which address one or more of the issues disclosed herein.

A first aspect of the present disclosure provides a method performed by a first network node. The method comprises: receiving from a second network node, a message indicating a plurality of location reporting request types; and reporting a location of a terminal device to the second network node, when a location reporting request type in the plurality of location reporting request types is satisfied.

In embodiments of the present disclosure, the message may include a first information element, IE, indicating a first location reporting request type, and a second IE indicating a second location reporting request type.

In embodiments of the present disclosure, the first location reporting request type may be change of serving cell, or UE presence in the area of interest. The second location reporting request type may be UE presence in the area of interest, or change of serving cell.

In embodiments of the present disclosure, the first IE may be a location reporting request type IE. The second IE may be an additional location reporting request type list.

In embodiments of the present disclosure, the second IE may indicate one or more location reporting request types.

In embodiments of the present disclosure, the message may include a location reporting request type IE, including an enumerated value indicating the first location reporting request type and the second location reporting request type.

In embodiments of the present disclosure, the location reporting request type IE may be configured with a first enumerated value indicating the first location reporting request type and the second location reporting request type; or a second enumerated value indicating a stop of the first location reporting request type and the second location reporting request type.

In embodiments of the present disclosure, the message may be transmitted via a next generation application protocol, NGAP, interface.

In embodiments of the present disclosure, the message may be a location reporting control message. Or, the message may be an initial context setup request message. Or, the message may be a handover request message.

In embodiments of the present disclosure, the message may be for triggering a location report when the terminal device is in a connected mode. Or, the message may be for triggering a location report when the terminal device is reconnected. Or, the message may be for triggering a location report when a N2-based handover happens for the terminal device.

In embodiments of the present disclosure, the first network node may be in a next generation-radio access network, NG-RAN. The second network node may be an access and mobility management function, AMF.

A second aspect of the present disclosure provides a method performed by a second network node. The method comprises: transmitting to a first network node, a message indicating a plurality of location reporting request types. The message indicates the first network node to report a location of a terminal device to the second network node, when a location reporting request type in the plurality of location reporting request types is satisfied.

In embodiments of the present disclosure, the message may include a first information element, IE, indicating a first location reporting request type, and a second IE indicating a second location reporting request type.

In embodiments of the present disclosure, the first location reporting request type may be change of serving cell, or UE presence in the area of interest. The second location reporting request type may be UE presence in the area of interest, or change of serving cell.

In embodiments of the present disclosure, the first IE may be a location reporting request type IE. The second IE may be an additional location reporting request type list.

In embodiments of the present disclosure, the second IE may indicate one or more location reporting request types.

In embodiments of the present disclosure, the message may include a location reporting request type IE, including an enumerated value indicating the first location reporting request type and the second location reporting request type.

In embodiments of the present disclosure, the location reporting request type IE may be configured with a first enumerated value indicating the first location reporting request type and the second location reporting request type; or a second enumerated value indicating a stop of the first location reporting request type and the second location reporting request type.

In embodiments of the present disclosure, the message may be transmitted via a next generation application protocol, NGAP, interface.

In embodiments of the present disclosure, the message may be a location reporting control message. Or the message may be an initial context setup request message. Or, the message may be a handover request message.

In embodiments of the present disclosure, the message may be for triggering a location report when the terminal device is in a connected mode. Or, the message may be for triggering a location report when the terminal device is reconnected. Or, the message is for triggering a location report when a N2-based handover happens for the terminal device.

In embodiments of the present disclosure, the first network node may be in a next generation-radio access network, NG-RAN. The second network node may be an access and mobility management function, AMF.

A third aspect of the present disclosure provides an apparatus for a first network node. The apparatus for the first network node comprises: a processor; and a memory. The memory contains instructions executable by the processor. The apparatus for the first network node is operative for: receiving from a second network node, a message indicating a plurality of location reporting request types; and reporting a location of a terminal device to the second network node, when a location reporting request type in the plurality of location reporting request types is satisfied.

In embodiments of the present disclosure, the apparatus may be further operative to perform the method according to any of above embodiments.

A fourth aspect of the present disclosure provides an apparatus for a second network node. The apparatus for the second network node comprises: a processor; and a memory. The memory contains instructions executable by the processor. The apparatus for the second network node is operative for: transmitting to a first network node, a message indicating a plurality of location reporting request types. The message indicates the first network node to report a location of a terminal device to the second network node, when a location reporting request type in the plurality of location reporting request types is satisfied.

In embodiments of the present disclosure, the apparatus may be further operative to perform the method according to any of above embodiments.

A fifth aspect of the present disclosure provides computer-readable storage medium storing instructions, which when executed by at least one processor, cause the at least one processor to perform the method according to any of above embodiments.

Another aspect of the present disclosure provides a host configured to operate in a communication system to provide an over-the-top (OTT) service. The host comprises: processing circuitry configured to provide user data; and a network interface configured to initiate transmission of the user data to a network node in a cellular network for transmission to a user equipment (UE). The network node has a communication interface and processing circuitry. The processing circuitry of the network node is configured to perform any of the method performed by the first network node and/or the second network node to transmit the user data from the host to the UE.

In embodiments of the present disclosure, the processing circuitry of the host is configured to execute a host application that provides the user data; and the UE comprises processing circuitry configured to execute a client application associated with the host application to receive the transmission of user data from the host.

Another aspect of the present disclosure provides a method implemented in a host configured to operate in a communication system that further includes a network node and a user equipment (UE). The method comprises: providing user data for the UE; and initiating a transmission carrying the user data to the UE via a cellular network comprising the network node. The network node performs any of the method performed by the first network node and/or the second network node to transmit the user data from the host to the UE.

In embodiments of the present disclosure, the method further comprises, at the network node, transmitting the user data provided by the host for the UE.

In embodiments of the present disclosure, the user data is provided at the host by executing a host application that interacts with a client application executing on the UE, the client application being associated with the host application.

Another aspect of the present disclosure provides a communication system configured to provide an over-the-top service. The communication system comprises: a host comprising: processing circuitry configured to provide user data for a user equipment (UE), the user data being associated with the over-the-top service; and a network interface configured to initiate transmission of the user data toward a cellular network node for transmission to the UE. The network node has a communication interface and processing circuitry. The processing circuitry of the network node is configured to perform any of the method performed by the first network node and/or the second network node to transmit the user data from the host to the UE.

In embodiments of the present disclosure, the communication system of the previous embodiment, further comprise: the network node; and/or the user equipment.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a host configured to operate in a communication system to provide an over-the-top (OTT) service. The host comprises: processing circuitry configured to initiate reception of user data; and a network interface configured to receive the user data from a network node in a cellular network, the network node having a communication interface and processing circuitry. The processing circuitry of the network node is configured to perform any of the method performed by the first network node and/or the second network node to receive the user data from the UE for the host.

In embodiments of the present disclosure, the processing circuitry of the host is configured to execute a host application, thereby providing the user data; and the host application is configured to interact with a client application executing on the UE, the client application being associated with the host application.

In embodiments of the present disclosure, the initiating reception of the user data comprises requesting the user data.

Another aspect of the present disclosure provides a method implemented by a host configured to operate in a communication system that further includes a network node and a user equipment (UE). The method comprising: at the host, initiating reception of user data from the UE, the user data originating from a transmission which the network node has received from the UE. The network node performs any of the method performed by the first network node and/or the second network node to receive the user data from the UE for the host.

In embodiments of the present disclosure, the method of the previous embodiment, further comprising at the network node, transmitting the received user data to the host.

Another aspect of the present disclosure provides a host configured to operate in a communication system to provide an over-the-top (OTT) service. The host comprises: processing circuitry configured to provide user data; and a network interface configured to initiate transmission of the user data to a cellular network for transmission to a user equipment (UE). The UE comprises a communication interface and processing circuitry, the communication interface and processing circuitry of the UE being configured to perform any of the method to receive the user data from the host.

In embodiments of the present disclosure, the cellular network further includes a network node configured to communicate with the UE to transmit the user data to the UE from the host.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a method implemented by a host operating in a communication system that further includes a network node and a user equipment (UE). The method comprising: providing user data for the UE; and initiating a transmission carrying the user data to the UE via a cellular network comprising the network node. The UE performs any of the method performed by the first network node and/or the second network node to receive the user data from the host.

In embodiments of the present disclosure, the method of the previous embodiment, further comprises: at the host, executing a host application associated with a client application executing on the UE to receive the user data from the UE.

In embodiments of the present disclosure, the method of the previous embodiment further comprises: at the host, transmitting input data to the client application executing on the UE, the input data being provided by executing the host application. The user data is provided by the client application in response to the input data from the host application.

Another aspect of the present disclosure provides a host configured to operate in a communication system to provide an over-the-top (OTT) service. The host comprises: processing circuitry configured to utilize user data; and a network interface configured to reception of transmission of the user data to a cellular network for transmission to a user equipment (UE). The UE comprises a communication interface and processing circuitry, the communication interface and processing circuitry of the UE being configured to perform any of the method to transmit the user data to the host.

In embodiments of the present disclosure, the cellular network further includes a network node configured to communicate with the UE to transmit the user data from the UE to the host.

In embodiments of the present disclosure, the processing circuitry of the host is configured to execute a host application, thereby providing the user data; and the host application is configured to interact with a client application executing on the UE, the client application being associated with the host application.

Another aspect of the present disclosure provides a method implemented by a host configured to operate in a communication system that further includes a network node and a user equipment (UE). The method comprises: at the host, receiving user data transmitted to the host via the network node by the UE. The UE performs any of the method performed by the first network node and/or the second network node transmit the user data to the host.

In embodiments of the present disclosure, the method of the previous embodiment, further comprises: at the host, executing a host application associated with a client application executing on the UE to receive the user data from the UE.

In embodiments of the present disclosure, the method of the previous embodiments, further comprises: at the host, transmitting input data to the client application executing on the UE, the input data being provided by executing the host application. The user data is provided by the client application in response to the input data from the host application.

Embodiments herein afford many advantages. According to embodiments of the present disclosure, improved methods and improved apparatuses for configuring location reporting type may be provided.

Particularly, by including a plurality of location reporting request types in a message, AMF can configure multiple Location Reporting Request Types at the same time. Therefore, the efficiency may be improved.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is a first exemplary scenario for configuring a location reporting type.

FIG. 1B is a second exemplary scenario for configuring a location reporting type.

FIG. 1C is a third exemplary scenario for configuring a location reporting type.

FIG. 1D is a fourth exemplary scenario for configuring a location reporting type.

FIG. 2 is an exemplary flow chart for a method performed by a first network node, according to exemplary embodiments of the present disclosure.

FIG. 3 is an exemplary flow chart for a method performed by a second network node, according to exemplary embodiments of the present disclosure.

FIG. 4A is a diagram showing an application of the alternative 1 in the first exemplary scenario for configuring a location reporting type.

FIG. 4B is a diagram showing an application of the alternative 1 in the second exemplary scenario for configuring a location reporting type.

FIG. 4C is a diagram showing an application of the alternative 1 in the third exemplary scenario for configuring a location reporting type.

FIG. 4D is a diagram showing an application of the alternative 1 in the fourth exemplary scenario for configuring a location reporting type.

FIG. 5A is a diagram showing an application of the alternative 2 in the first exemplary scenario for configuring a location reporting type.

FIG. 5B is a diagram showing an application of the alternative 2 in the second exemplary scenario for configuring a location reporting type.

FIG. 5C is a diagram showing an application of the alternative 2 in the third exemplary scenario for configuring a location reporting type.

FIG. 5D is a diagram showing an application of the alternative 2 in the fourth exemplary scenario for configuring a location reporting type.

FIG. 6 is a diagram showing a procedure for location reporting control.

FIG. 7A is a block diagram showing an exemplary apparatus for a first network node, which is suitable for performing the method according to embodiments of the disclosure.

FIG. 7B is a block diagram showing an exemplary apparatus for a second network node, which is suitable for performing the method according to embodiments of the disclosure.

FIG. 8 is a block diagram showing an apparatus/computer readable storage medium, according to embodiments of the present disclosure.

FIG. 9A is a block diagram showing modules for a first network node, which are suitable for performing the method according to embodiments of the disclosure.

FIG. 9B is a block diagram showing modules for a second network node, which are suitable for performing the method according to embodiments of the disclosure.

FIG. 10 shows an example of a communication system 1000 in accordance with some embodiments.

FIG. 11 shows a UE 1100 in accordance with some embodiments.

FIG. 12 shows a network node 1200 in accordance with some embodiments.

FIG. 13 is a block diagram of a host 1300, which may be an embodiment of the host 1016 of FIG. 10, in accordance with various aspects described herein.

FIG. 14 is a block diagram illustrating a virtualization environment 1400 in which functions implemented by some embodiments may be virtualized.

FIG. 15 shows a communication diagram of a host 1502 communicating via a network node 1504 with a UE 1506 over a partially wireless connection in accordance with some embodiments.

FIG. 16 is a diagram showing a procedure for location reporting control.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such for an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

As examples for configuring location reporting request type, the following scenarios are illustrated.

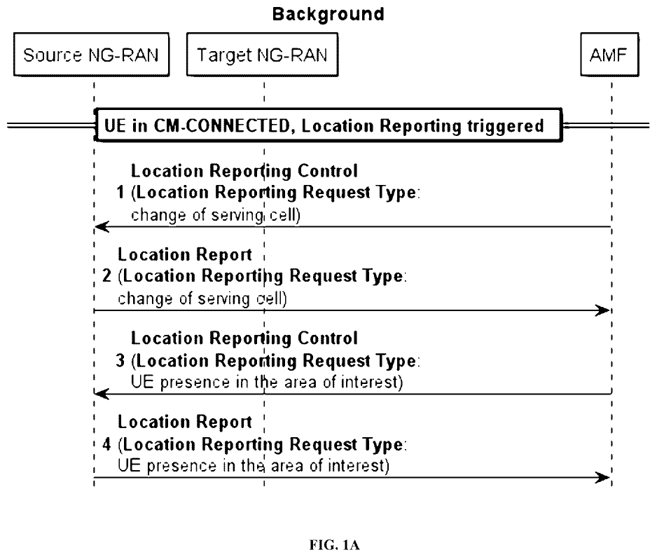

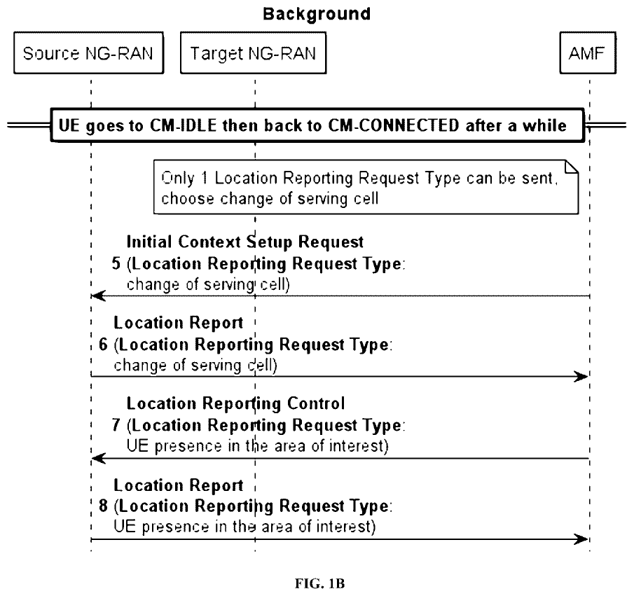

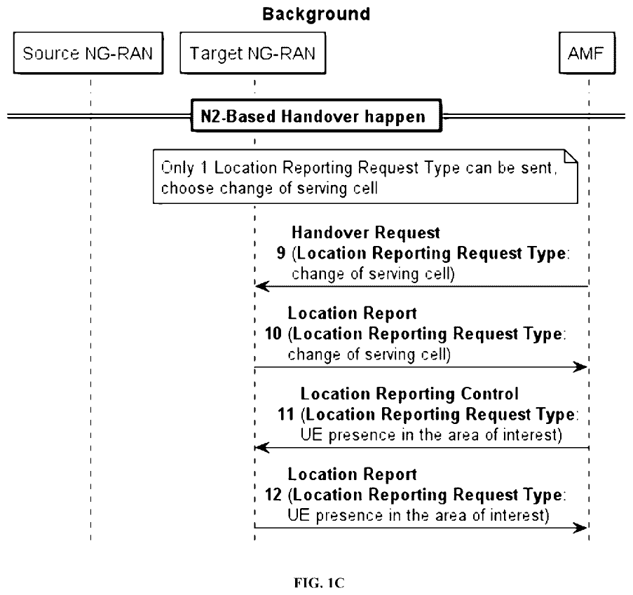

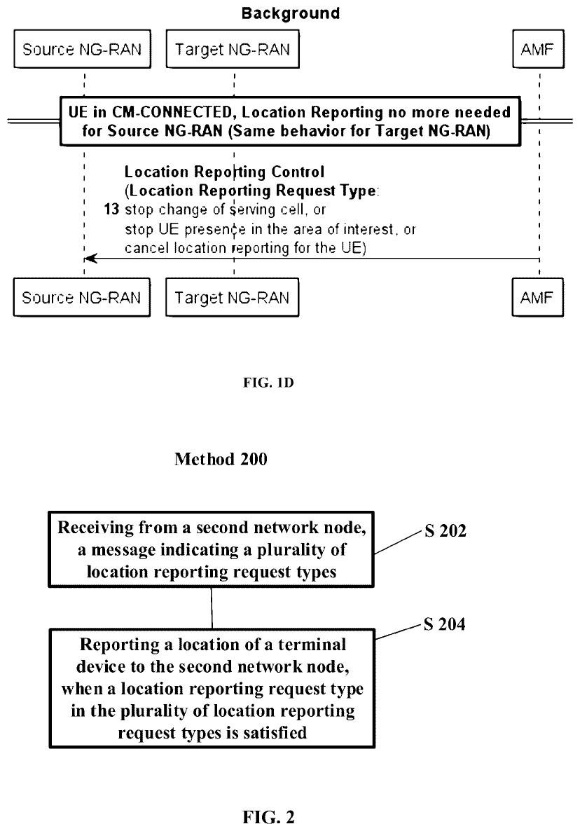

FIG. 1A is a first exemplary scenario for configuring a location reporting type.

As shown in FIG. 1A, in the first exemplary scenario, the location reporting is triggered when the UE is in a CM-CONNECTED state.

In a step 1, the AMF sends a location reporting control message, including an IE location reporting request type, with a value indicating “change of serving cell”.

In a step 2, the source NG-RAN node transmits a location report, including an IE location reporting request type, with a value indicating “change of serving cell”.

In a step 3, the AMF sends a location reporting control message, including an IE location reporting request type, with a value indicating “UE presence in the area of interest”.

In a step 4, the source NG-RAN node transmits a location report, including an IE location reporting request type, with a value indicating “UE presence in the area of interest”.

FIG. 1B is a second exemplary scenario for configuring a location reporting type.

As shown in FIG. 1B, in the second exemplary scenario, the location reporting is triggered when the UE goes to CM-IDLE state and then back to a CM-CONNECTED state after a while.

As illustrated, only 1 location reporting request type can be sent at one time, then “change of servicing cell” is chose firstly.

In a step 5, the AMF sends an initial context setup request message, including an IE location reporting request type, with a value indicating “change of serving cell”.

In a step 6, the source NG-RAN node transmits a location report, including an IE location reporting request type, with a value indicating “change of serving cell”.

In a step 7, the AMF sends a location reporting control message, including an IE location reporting request type, with a value indicating “UE presence in the area of interest”.

In a step 8, the source NG-RAN node transmits a location report, including an IE location reporting request type, with a value indicating “UE presence in the area of interest”.

FIG. 1C is a third exemplary scenario for configuring a location reporting type.

As shown in FIG. 1C, in the third exemplary scenario, the location reporting is triggered when N2-Based Handover happens.

As illustrated, only 1 location reporting request type can be sent at one time, then “change of servicing cell” is chose firstly.

In a step 9, the AMF sends a handover request message, including an IE location reporting request type, with a value indicating “change of serving cell”.

In a step 10, the target NG-RAN node transmits a location report, including an IE location reporting request type, with a value indicating “change of serving cell”.

In a step 11, the AMF sends a location reporting control message, including an IE location reporting request type, with a value indicating “UE presence in the area of interest”.

In a step 12, the target NG-RAN node transmits a location report, including an IE location reporting request type, with a value indicating “UE presence in the area of interest”.

FIG. 1D is a fourth exemplary scenario for configuring a location reporting type.

As shown in FIG. 1D, in the fourth exemplary scenario, the location reporting is no more needed for source NG-RAN when the UE is in CM-CONNECTED state. The procedure will be the same for target NG-RAN.

In a step 13, the AMF sends a location reporting control message, including an IE location reporting request type, with a value indicating “stop change of serving cell”, or “stop UE presence in the area of interest”, or “cancel location reporting for the UE”.

In summary, location reporting procedure allows AMF to request the NG-RAN node to report the UE's location, or the UE's presence in the area of interest while in CM-CONNECTED state. AMF will send Location Reporting Request Type IE to NG-RAN in below NGAP messages if Location Reporting is needed:
1. Location Reporting Control (see above steps 1, 3, 7, 11, 13)
   For example: If UE in CM-CONNECTED and AMF receive Event Exposure service to provide the location information to SBI (service based interface) service consumer.
2. Initial Context Setup Request (see above step 5)
   After UE from CM-IDLE to CM-CONNECTED.
3. Handover Request (see above step 9)
   N2-Based handover happened, AMF shall send the location reporting information to the target NG-RAN.

The Location Reporting Request Type IE indicates to the NG-RAN node whether:
to report directly;
to report upon change of serving cell;
to report UE presence in the area of interest;
to stop reporting at change of serving cell;
to stop reporting UE presence in the area of interest;
to cancel location reporting for the UE.

In these exemplary scenarios, some problems exist.

If both Location Reporting Request Type change of serving cell and UE presence in the area of interest needed at the same time, then,
1. For Location Reporting Control message, AMF needs to send two messages to NG-RAN to request the above two Location Reporting Request Types. It should be fine since different Location Reporting Request Type will be triggered in different time normally.
2. For Initial Context Setup Request, AMF can send only one Location Reporting Request Type to NG-RAN in the message, for other Location Reporting Request Type, AMF must trigger one more additional Location Reporting Control message. It looks not reasonable.
3. For Handover Request, AMF can send only one Location Reporting Request Type to NG-RAN, for other Location Reporting Request Type, AMF must trigger one more additional Location Reporting Control message. It looks not reasonable.

When in the future more Location Reporting Request Type will be included in the system, the drawback of the current specification would become not acceptable. e.g., for the location reporting types exist in the source NG-RAN node, after handover, they have to be triggered one by one. It may lose accuracy related to location reporting.

To solve the above problems, embodiments of the present disclosure propose the following solutions.

FIG. 2 is an exemplary flow chart for a method performed by a first network node, according to exemplary embodiments of the present disclosure.

As shown in FIG. 2, the method 200 comprises: a step S202, receiving from a second network node, a message indicating a plurality of location reporting request types; and a step S204, reporting a location of a terminal device to the second network node, when a location reporting request type in the plurality of location reporting request types is satisfied.

According to embodiments of the present disclosure, improved methods and improved apparatuses for configuring location reporting type may be provided.

Particularly, by including a plurality of location reporting request types in a message, AMF can configure multiple Location Reporting Request Types at the same time. Therefore, the efficiency may be improved.

For example, both of the location reporting request types “change of serving cell”, “UE presence in the area of interest” may be indicated. Then, when either of them is satisfied, namely, when the UE changes the serving cell or when UE goes into an area of interest, the location report will be triggered.

In embodiments of the present disclosure, the message may include a first information element, IE, indicating a first location reporting request type, and a second IE indicating a second location reporting request type.

In embodiments of the present disclosure, the first location reporting request type may be change of serving cell, or UE presence in the area of interest. The second location reporting request type may be UE presence in the area of interest, or change of serving cell.

In embodiments of the present disclosure, the first IE may be a location reporting request type IE. The second IE may be an additional location reporting request type list.

In embodiments of the present disclosure, the second IE may indicate one or more location reporting request types.

According to embodiments of the present disclosure, a new IE may be added.

In embodiments of the present disclosure, the message may include a location reporting request type IE, including an enumerated value indicating the first location reporting request type and the second location reporting request type.

In embodiments of the present disclosure, the location reporting request type IE may be configured with a first enumerated value indicating the first location reporting request type and the second location reporting request type; or a second enumerated value indicating a stop of the first location reporting request type and the second location reporting request type.

According to embodiments of the present disclosure, new values may be added to existing IE.

In embodiments of the present disclosure, the message may be transmitted via a next generation application protocol, NGAP, interface.

In embodiments of the present disclosure, the message may be a location reporting control message. Or, the message may be an initial context setup request message. Or, the message may be a handover request message.

In embodiments of the present disclosure, the message may be for triggering a location report when the terminal device is in a connected mode. Or, the message may be for triggering a location report when the terminal device is reconnected. Or, the message may be for triggering a location report when a N2-based handover happens for the terminal device.

In embodiments of the present disclosure, the first network node may be in a next generation-radio access network, NG-RAN. The second network node may be an access and mobility management function, AMF.

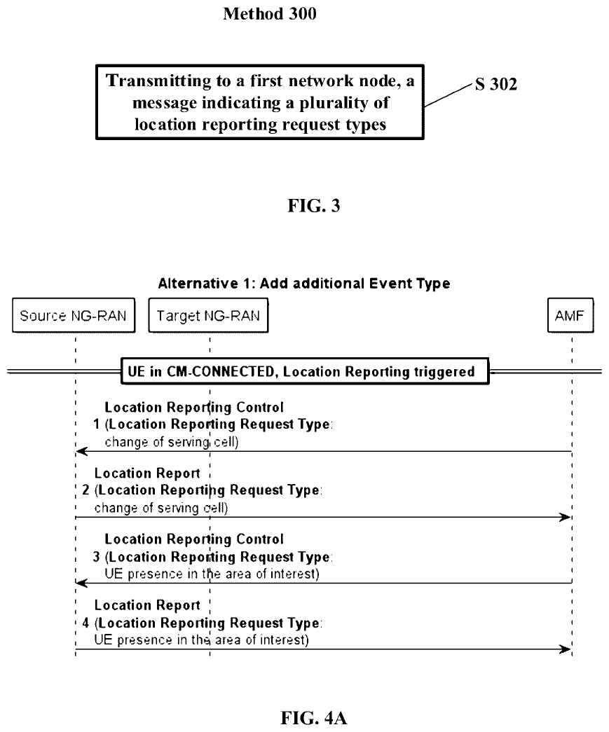

FIG. 3 is an exemplary flow chart for a method performed by a second network node, according to exemplary embodiments of the present disclosure.

As shown in FIG. 3, the method 300 comprises: a step S302, transmitting to a first network node, a message indicating a plurality of location reporting request types. The message indicates the first network node to report a location of a terminal device to the second network node, when a location reporting request type in the plurality of location reporting request types is satisfied.

In embodiments of the present disclosure, the message may include a first information element, IE, indicating a first location reporting request type, and a second IE indicating a second location reporting request type.

In embodiments of the present disclosure, the first location reporting request type may be change of serving cell, or UE presence in the area of interest. The second location reporting request type may be UE presence in the area of interest, or change of serving cell.

In embodiments of the present disclosure, the first IE may be a location reporting request type IE. The second IE may be an additional location reporting request type list.

In embodiments of the present disclosure, the second IE may indicate one or more location reporting request types.

In embodiments of the present disclosure, the message may include a location reporting request type IE, including an enumerated value indicating the first location reporting request type and the second location reporting request type.

In embodiments of the present disclosure, the location reporting request type IE may be configured with a first enumerated value indicating the first location reporting request type and the second location reporting request type; or a second enumerated value indicating a stop of the first location reporting request type and the second location reporting request type.

In embodiments of the present disclosure, the message may be transmitted via a next generation application protocol, NGAP, interface.

In embodiments of the present disclosure, the message may be a location reporting control message. Or the message may be an initial context setup request message. Or, the message may be a handover request message.

In embodiments of the present disclosure, the message may be for triggering a location report when the terminal device is in a connected mode. Or, the message may be for triggering a location report when the terminal device is reconnected. Or, the message is for triggering a location report when a N2-based handover happens for the terminal device.

In embodiments of the present disclosure, the first network node may be in a next generation-radio access network, NG-RAN. The second network node may be an access and mobility management function, AMF.

According to embodiments of the present disclosure, at least two main alternatives are proposed.

As alternative 1, the Initial Context Setup Request, Handover Request message, and/or location reporting control message may be extended, to include the additional Location Reporting Request Type.

As alternative 2, the Location Reporting Request Type IE may be extended. For example, two new types which contains start and stop both Location Reporting Request Type of change of serving cell and UE presence in the area of interest may be added.

AMF can configure multiple Location Reporting Request Types in Initial Context Setup Request, Handover Request, and/or Location Reporting Control by adding new IE in those messages, or by extending the Location Reporting Request Type IE, when the requests for multiple types exist at the same time.

The advantages of embodiments of the present disclosure at least include:
1. Signaling upon NGAP interface will be saved when multiple Event Types need to be sent to NG-RAN for Location Reporting. The Initial Context Setup Request, the Handover Request message, and/or the Location Reporting Control message can contain more than one Location Reporting Request Type to starting Location Reporting procedure.
2. The location reporting is more accurate after e.g., NG based handover.

According to embodiments of the present disclosure, more detailed application of the present disclosure will be illustrated below.

As alternative 1, a new IE: Additional Location Reporting Request Type List may be introduced in Initial Context Setup Request and Handover Request. If more than one Location Reporting Request Type need to be sent in those messages, then the first Location Reporting Request Type may be put to the existing IE: Location Reporting Request Type and the rest of the Location Reporting Request Type may be put to the new IE.

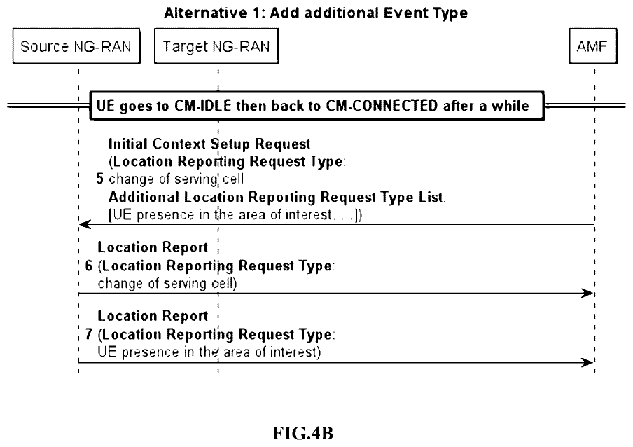

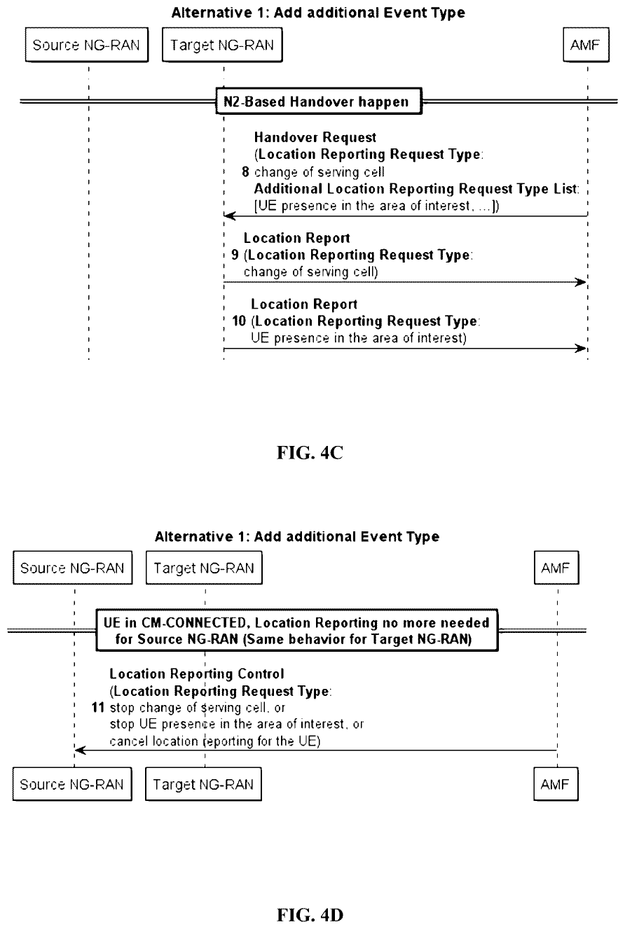

FIG. 4A is a diagram showing an application of the alternative 1 in the first exemplary scenario for configuring a location reporting type.

As shown in FIG. 4A, in the first exemplary scenario, the location reporting is triggered when the UE is in a CM-CONNECTED state.

In a step 1, the AMF sends a location reporting control message, including an IE location reporting request type, with a value indicating “change of serving cell”.

In a step 2, the source NG-RAN node transmits a location report, including an IE location reporting request type, with a value indicating “change of serving cell”.

In a step 3, the AMF sends a location reporting control message, including an IE location reporting request type, with a value indicating “UE presence in the area of interest”.

In a step 4, the source NG-RAN node transmits a location report, including an IE location reporting request type, with a value indicating “UE presence in the area of interest”.

In this example, the new IE “Additional Location Reporting Request Type List” is not applied in the message “location reporting control message”. However, it should be understood that, this new IE may be also applied in the message “location reporting control message”.

FIG. 4B is a diagram showing an application of the alternative 1 in the second exemplary scenario for configuring a location reporting type.

As shown in FIG. 4B, in the second exemplary scenario, the location reporting is triggered when the UE goes to CM-IDLE state and then back to a CM-CONNECTED state after a while.

In a step 5, the AMF sends an initial context setup request message, including an IE location reporting request type, with a value indicating “change of serving cell”, and including an IE “Additional location reporting request type list”, with a value indicating “UE presence in the area of interest”.

In a step 6, the source NG-RAN node transmits a location report, including an IE location reporting request type, with a value indicating “change of serving cell”.

In a step 7, the source NG-RAN node transmits a location report, including an IE location reporting request type, with a value indicating “UE presence in the area of interest”.

FIG. 4C is a diagram showing an application of the alternative 1 in the third exemplary scenario for configuring a location reporting type.

As shown in FIG. 4C, in the third exemplary scenario, the location reporting is triggered when N2-Based Handover happens.

In a step 8, the AMF sends a handover request message, including an IE location reporting request type, with a value indicating “change of serving cell”, and including an IE “Additional location reporting request type list”, with a value indicating “UE presence in the area of interest”.

In a step 9, the target NG-RAN node transmits a location report, including an IE location reporting request type, with a value indicating “change of serving cell”.

In a step 10, the target NG-RAN node transmits a location report, including an IE location reporting request type, with a value indicating “UE presence in the area of interest”.

FIG. 4D is a diagram showing an application of the alternative 1 in the fourth exemplary scenario for configuring a location reporting type.

As shown in FIG. 4D, in the fourth exemplary scenario, the location reporting is no more needed for source NG-RAN when the UE is in CM-CONNECTED state. The procedure will be the same for target NG-RAN.

In a step 11, the AMF sends a location reporting control message, including an IE location reporting request type, with a value indicating “stop change of serving cell”, or “stop UE presence in the area of interest”, or “cancel location reporting for the UE”.

This solution is extendable in future, there will be no need to change the solution again even if new Location Reporting Request Type is introduced in future.

Further, the Location Reporting Control message or one Location Report message may be, or may not be improved with the new IE. Namely, it may be optional.

Alternatively, instead of introducing the new list, the IE “additional Location Reporting Request Type” is introduced to the above messages, so the second location reporting type can be triggered during the Initial Context Setup Request, and Handover Request.

As alternative 2, existing IE: Location Reporting Request Type may be extended, by adding 2 more enumerated value with following name:
1. change of serving cell and area of interest
2. stop change of serving cell and area of interest

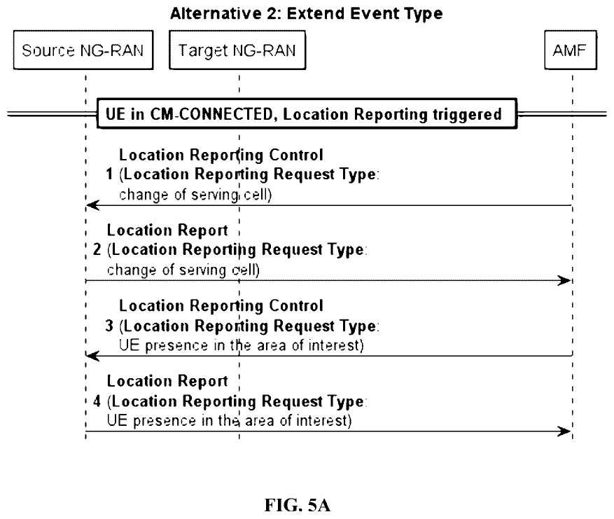

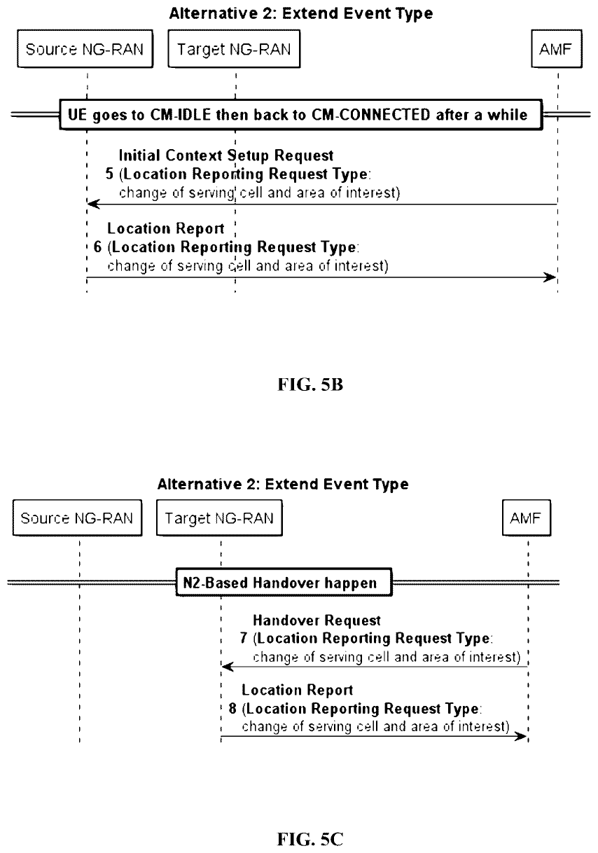

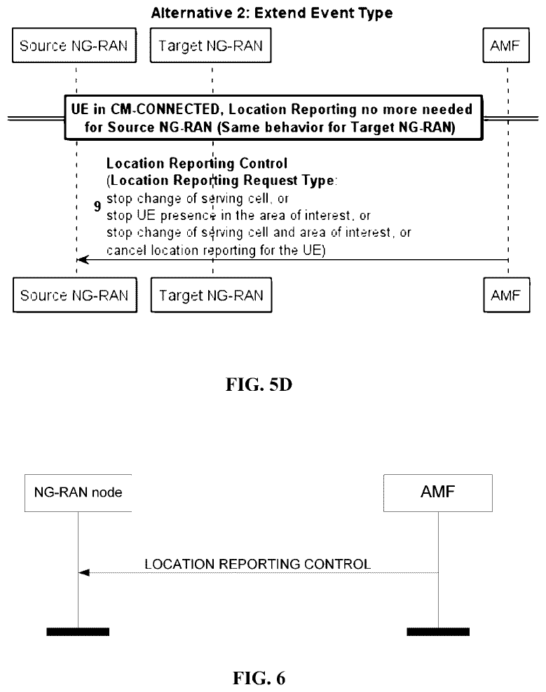

FIG. 5A is a diagram showing an application of the alternative 2 in the first exemplary scenario for configuring a location reporting type.

As shown in FIG. 5A, in a step 1, the AMF sends a location reporting control message, including an IE location reporting request type, with a value indicating “change of serving cell”.

In a step 2, the source NG-RAN node transmits a location report, including an IE location reporting request type, with a value indicating “change of serving cell”.

In a step 3, the AMF sends a location reporting control message, including an IE location reporting request type, with a value indicating “UE presence in the area of interest”.

In a step 4, the source NG-RAN node transmits a location report, including an IE location reporting request type, with a value indicating “UE presence in the area of interest”.

In this example, the new value “change of serving cell and area of interest” for the IE “Location Reporting Request Type” is not applied in the message “location reporting control message”. However, it should be understood that, this new value of the IE may be also applied in the message “location reporting control message”.

FIG. 5B is a diagram showing an application of the alternative 2 in the second exemplary scenario for configuring a location reporting type.

As shown in FIG. 5B, in a step 5, the AMF sends an initial context setup request message, including an IE location reporting request type, with a value indicating “change of serving cell and area of interest”.

In a step 6, the source NG-RAN node transmits a location report, including an IE location reporting request type, with a value indicating “change of serving cell and area of interest”.

FIG. 5C is a diagram showing an application of the alternative 2 in the third exemplary scenario for configuring a location reporting type.

As shown in FIG. 5C, in a step 7, the AMF sends a handover request message, including an IE location reporting request type, with a value indicating “change of serving cell and area of interest”.

In a step 8, the target NG-RAN node transmits a location report, including an IE location reporting request type, with a value indicating “change of serving cell and area of interest”.

FIG. 5D is a diagram showing an application of the alternative 2 in the fourth exemplary scenario for configuring a location reporting type.

As shown in FIG. 5D, in a step 9, the AMF sends a location reporting control message, including an IE location reporting request type, with a value indicating “stop change of serving cell”, or “stop UE presence in the area of interest”, or “stop change of serving cell and area of interest”, or “cancel location reporting for the UE”.

In this way, multiple Location Reporting Request Type will be more easily supported in 1 message of Location Reporting Control, Location Report, Initial Context Setup Request and Handover Request.

The exemplary details of the added/improved IEs will be illustrated below.

As to alternative 1, the detailed improvement (underlined parts) may be also applied to 3GPP TS38.413 V17.0.0.

### 9.2.2.1 Initial Context Setup Request.

This message is sent by the AMF to request the setup of a UE context.
Direction: AMF→NG-RAN node

| | | | | | | Assigned |
|---|---|---|---|---|---|---|
| | | | IE type and | Semantics | Criti- | Criti- |
| IE/Group Name | Presence | Range | reference | description | cality | cality |
| Message Type | M | | 9.3.1.1 | | YES | reject |
| AMF UE NGAP ID | M | | 9.3.3.1 | | YES | reject |
| RAN UE NGAP ID | M | | 9.3.3.2 | | YES | reject |
| Old AMF | O | | AMF Name | | YES | reject |
| | | | 9.3.3.21 | | | |
| UE Aggregate | C- | | 9.3.1.58 | | YES | reject |
| Maximum Bit Rate | ifPDUsessionResourceSetup | | | | | |
| Core Network | O | | 9.3.1.15 | | YES | ignore |
| Assistance Information | | | | | | |
| for RRC INACTIVE | | | | | | |
| GUAMI | M | | 9.3.3.3 | | YES | reject |
| PDU Session Resource | | 0 . . . 1 | | | YES | reject |
| Setup Request List | | | | | | |
| >PDU Session | | 1 . . . | | | — | |
| Resource Setup | | <maxnoofPDUSessions> | | | | |
| Request Item | | | | | | |
| >>PDU Session ID | M | | 9.3.1.50 | | — | |
| >>PDU Session | O | | NAS-PDU | | — | |
| NAS-PDU | | | 9.3.3.4 | | | |
| >>S-NSSAI | M | | 9.3.1.24 | | — | |
| >>PDU Session | M | | OCTET | Containing the | — | |
| Resource Setup | | | STRING | PDU Session | | |
| Request Transfer | | | | Resource Setup | | |
| | | | | Request Transfer | | |
| | | | | IE specified in | | |
| | | | | subclause 9.3.4.1. | | |
| >>PDU Session | O | | Expected UE | Expected UE | YES | ignore |
| Expected UE Activity | | | Activity | Activity | | |
| Behaviour | | | Behaviour | Behaviour for the | | |
| | | | 9.3.1.94 | PDU Session. | | |
| Allowed NSSAI | M | | 9.3.1.31 | Indicates the S- | YES | reject |
| | | | | NSSAIs permitted | | |
| | | | | by the network | | |
| UE Security | M | | 9.3.1.86 | | YES | reject |
| Capabilities | | | | | | |
| Security Key | M | | 9.3.1.87 | | YES | reject |
| Trace Activation | O | | 9.3.1.14 | | YES | ignore |
| Mobility Restriction | O | | 9.3.1.85 | | YES | ignore |
| List | | | | | | |
| UE Radio Capability | O | | 9.3.1.74 | | YES | ignore |
| Index to | O | | 9.3.1.61 | | YES | ignore |
| RAT/Frequency | | | | | | |
| Selection Priority | | | | | | |
| Masked IMEISV | O | | 9.3.1.54 | | YES | ignore |
| NAS-PDU | O | | 9.3.3.4 | | YES | ignore |
| Emergency Fallback | O | | 9.3.1.26 | | YES | reject |
| Indicator | | | | | | |
| RRC Inactive | O | | 9.3.1.91 | | YES | ignore |
| Transition Report | | | | | | |
| Request | | | | | | |
| UE Radio Capability | O | | 9.3.1.68 | | YES | ignore |
| for Paging | | | | | | |
| Redirection for Voice | O | | 9.3.1.116 | | YES | ignore |
| EPS Fallback | | | | | | |
| Location Reporting | O | | 9.3.1.65 | | YES | ignore |
| Request Type | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| IAB Authorized | O | | 9.3.1.129 | | YES | ignore |
| Enhanced Coverage | O | | 9.3.1.140 | | YES | ignore |
| Restriction | | | | | | |
| Extended Connected | O | | 9.3.3.31 | | YES | ignore |
| Time | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum | | | | only if the UE is | | |
| Bit Rate | | | | authorized for NR | | |
| | | | | V2X services. | | |
| LTE UE Sidelink | O | | 9.3.1.149 | This IE applies | YES | ignore |
| Aggregate Maximum | | | | only if the UE is | | |
| Bit Rate | | | | authorized for | | |
| | | | | LTE V2X | | |
| | | | | services. | | |
| PC5 QoS Parameters | O | | 9.3.1.150 | This IE applies | YES | ignore |
| | | | | only if the UE is | | |
| | | | | authorized for NR | | |
| | | | | V2X services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| RG Level Wireline | O | | OCTET | Specified in TS | YES | ignore |
| Access Characteristics | | | STRING | 23.316 [34]. | | |
| | | | | Indicates the | | |
| | | | | wireline access | | |
| | | | | technology | | |
| | | | | specific QoS | | |
| | | | | information | | |
| | | | | corresponding to | | |
| | | | | a specific wireline | | |
| | | | | access | | |
| | | | | subscription. | | |
| Management Based | O | | MDT PLMN | | YES | ignore |
| MDT PLMN List | | | List | | | |
| | | | 9.3.1.168 | | | |
| UE Radio Capability ID | O | | 9.3.1.142 | | YES | reject |
| Time Synchronisation | O | | 9.3.1.220 | | YES | ignore |
| Assistance Information | | | | | | |
| QMC Configuration | O | | 9.3.1.223 | | YES | ignore |
| Information | | | | | | |
| Target NSSAI | O | | 9.3.1.229 | | YES | ignore |
| Information | | | | | | |
| UE Slice Maximum Bit | O | | 9.3.1.231 | | YES | ignore |
| Rate List | | | | | | |
| 5G ProSe Authorized | O | | 9.3.1.233 | | YES | ignore |
| 5G ProSe UE PC5 | O | | NR UE Sidelink | This IE applies | YES | ignore |
| Aggregate Maximum | | | Aggregate | only if the UE is | | |
| Bit Rate | | | Maximum Bit | authorized for 5G | | |
| | | | Rate | ProSe services. | | |
| | | | 9.3.1.148 | | | |
| 5G ProSe PC5 QoS | O | | 9.3.1.234 | This IE applies | YES | ignore |
| Parameters | | | | only if the UE is | | |
| | | | | authorized for 5G | | |
| | | | | ProSe services. | | |
| Additional Location | | 0 . . . 1 | | | YES | ignore |
| Reporting Request | | | | | | |
| Type List | | | | | | |
| >Additional Location | | 1 . . . | | | — | |
| Reporting Request | | <maxnoofAdditionalLocatonItem> | | | | |
| Type Item | | | | | | |
| >>Additional Location | M | | Location | | — | |
| Reporting Request | | | Reporting | | | |
| Type | | | Request Type | | | |
| | | | 9.3.1.6.5 | | | |

| Range bound | Explanation |
|---|---|
| maxnoofPDUSessions | Maximum no. of PDU sessions allowed towards one UE. Value is 256. |
| maxnoofAdditionalLocationItem | Maximum no. of Additional Location Reporting Request Type. Value is 5. |

| Condition | Explanation |
|---|---|
| ifPDUsessionResourceSetup | This IE shall be present if the PDU Session Resource Setup List IE is present. |

### 9.2.3.4 Handover Request

This message is sent by the AMF to the target NG-RAN node to request the preparation of resources.
Direction: AMF→NG-RAN node.

| | | | | | | Assigned |
|---|---|---|---|---|---|---|
| | | | IE type and | Semantics | Criti- | Criti- |
| IE/Group Name | Presence | Range | reference | description | cality | cality |
| Message Type | M | | 9.3.1.1 | | YES | reject |
| AMF UE NGAP ID | M | | 9.3.3.1 | | YES | reject |
| Handover Type | M | | 9.3.1.22 | | YES | reject |
| Cause | M | | 9.3.1.2 | | YES | ignore |
| UE Aggregate | M | | 9.3.1.58 | | YES | reject |
| Maximum Bit Rate | | | | | | |
| Core Network | O | | 9.3.1.15 | | YES | ignore |
| Assistance Information | | | | | | |
| for RRC INACTIVE | | | | | | |
| UE Security | M | | 9.3.1.86 | | YES | reject |
| Capabilities | | | | | | |
| Security Context | M | | 9.3.1.88 | | YES | reject |
| New Security Context | O | | 9.3.1.55 | | YES | reject |
| Indicator | | | | | | |
| NASC | O | | NAS-PDU | Refers to either | YES | reject |
| | | | 9.3.3.4 | the “Intra NI | | |
| | | | | mode NAS | | |
| | | | | transparent | | |
| | | | | container” or the | | |
| | | | | “S1 mode to N1 | | |
| | | | | mode NAS | | |
| | | | | transparent | | |
| | | | | container”, the | | |
| | | | | details of the IE | | |
| | | | | definition and the | | |
| | | | | encoding | | |
| | | | | arespecified in TS | | |
| | | | | 24.501 [26]. | | |
| PDU Session Resource | | 1 | | | YES | reject |
| Setup List | | | | | | |
| >PDU Session | | 1 . . . | | | — | |
| Resource Setup Item | | <maxnoofPDUSessions> | | | | |
| >>PDU Session ID | M | | 9.3.1.50 | | — | |
| >>S-NSSAI | M | | 9.3.1.24 | | — | |
| >>Handover Request | M | | OCTET | Containing the | — | |
| Transfer | | | STRING | PDU Session | | |
| | | | | Resource Setup | | |
| | | | | Request Transfer | | |
| | | | | IE specified in | | |
| | | | | subclause 9.3.4.1. | | |
| >>PDU Session | O | | Expected UE | Expected UE | YES | ignore |
| Expected UE Activity | | | Activity | Activity | | |
| Behaviour | | | Behaviour | Behaviour for the | | |
| | | | 9.3.1.94 | PDU Session. | | |
| Allowed NSSAI | M | | 9.3.1.31 | Indicates the S- | YES | reject |
| | | | | NSSAIs permitted | | |
| | | | | by the network. | | |
| Trace Activation | O | | 9.3.1.14 | | YES | ignore |
| Masked IMEISV | O | | 9.3.1.54 | | YES | ignore |
| Source to Target | M | | 9.3.1.20 | | YES | reject |
| Transparent Container | | | | | | |
| Mobility Restriction | O | | 9.3.1.85 | | YES | ignore |
| List | | | | | | |
| Location Reporting | O | | 9.3.1.65 | | YES | ignore |
| Request Type | | | | | | |
| RRC Inactive | O | | 9.3.1.91 | | YES | ignore |
| Transition Report | | | | | | |
| Request | | | | | | |
| GUAMI | M | | 9.3.3.3 | | YES | reject |
| Redirection for Voice | O | | 9.3.1.116 | | YES | ignore |
| EPS Fallback | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| IAB Authorized | O | | 9.3.1.129 | | YES | reject |
| Enhanced Coverage | O | | 9.3.1.140 | | YES | ignore |
| Restriction | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum | | | | only if the UE is | | |
| Bit Rate | | | | authorized for NR | | |
| | | | | V2X services. | | |
| LTE UE Sidelink | O | | 9.3.1.149 | This IE applies | YES | ignore |
| Aggregate Maximum | | | | only if the UE is | | |
| Bit Rate | | | | authorized for | | |
| | | | | LTE V2X | | |
| | | | | services. | | |
| PC5 QoS Parameters | O | | 9.3.1.150 | This IE applies | YES | ignore |
| | | | | only if the UE is | | |
| | | | | authorized for NR | | |
| | | | | V2X services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| Management Based | O | | MDT PLMN | | YES | ignore |
| MDT PLMN List | | | List | | | |
| | | | 9.3.1.168 | | | |
| UE Radio Capability ID | O | | 9.3.1.142 | | YES | reject |
| Extended Connected | O | | 9.3.3.31 | | YES | ignore |
| Time | | | | | | |
| Time Synchronisation | O | | 9.3.1.220 | | YES | ignore |
| Assistance Information | | | | | | |
| UE Slice Maximum Bit | O | | 9.3.1.231 | | YES | ignore |
| Rate List | | | | | | |
| 5G ProSe Authorized | O | | 9.3.1.233 | | YES | ignore |
| 5G ProSe UE PC5 | O | | NR UE Sidelink | This IE applies | YES | ignore |
| Aggregate Maximum | | | Aggregate | only if the UE is | | |
| Bit Rate | | | Maximum Bit | authorized for 5G | | |
| | | | Rate | ProSe services. | | |
| | | | 9.3.1.148 | | | |
| 5G ProSe PC5 QoS | O | | 9.3.1.234 | This IE applies | YES | ignore |
| Parameters | | | | | | |
| | | | | only if the UE is | | |
| | | | | authorized for 5G | | |
| | | | | ProSe services. | | |
| Additional Location | | 0 . . . 1 | | | YES | ignore |
| Reporting Request | | | | | | |
| Type List | | | | | | |
| >Additional Location | | 1 . . . | | | — | |
| Reporting Request | | <maxnoofAdditionalLocationItem> | | | | |
| Type Item | | | | | | |
| >>Additional Location | M | | Location | | — | |
| Reporting Request | | | Reporting | | | |
| Type | | | Request Type | | | |
| | | | 9.3.1.6.5 | | | ZZZZZZZZZZZZ |

| Range bound | Explanation |
|---|---|
| maxnoofPDUSessions | Maximum no. of PDU sessions allowed towards one UE. Value is 256. |
| maxnoofAdditionalLocationItem | Maximum no. of Additional Location Reporting Request Type. Value is 5. |

As to alternative 2, the detailed improvement (underlined parts) may be also applied to 3GPP TS38.413 V17.0.0.

### 8.12.1.2 Successful Operation

### FIG. 8.12.1.2-1: Location Reporting Control (See FIG. 6)

The AMF initiates the procedure by sending a LOCATION REPORTING CONTROL message to the NG-RAN node. On receipt of the LOCATION REPORTING CONTROL message the NG-RAN node shall perform the requested location reporting control action for the UE.
The Location Reporting Request Type IE indicates to the NG-RAN node whether:
to report directly;
to report upon change of serving cell;
to report UE presence in the area of interest;
to stop reporting at change of serving cell;
to stop reporting UE presence in the area of interest;
to cancel location reporting for the UE.
to report upon change of serving cell and UE presence in the area of interest;
to stop reporting at change of serving cell and UE presence in the area of interest.

### 9.3.1.65 Location Reporting Request Type

This IE indicates the type of location request to be handled by the NG-RAN node.

| | | | | | | Assigned |
|---|---|---|---|---|---|---|
| | | | IE type and | Semantics | Criti- | Criti- |
| IE/Group Name | Presence | Range | reference | description | cality | cality |
| Event Type | M | | ENUMERATED | | — | |
| | | | (direct, change | | | |
| | | | of serving cell, | | | |
| | | | UE presence in | | | |
| | | | the area of | | | |
| | | | interest, stop | | | |
| | | | change of | | | |
| | | | serving cell, | | | |
| | | | stop UE | | | |
| | | | presence in the | | | |
| | | | area of interest, | | | |
| | | | cancel location | | | |
| | | | reporting for the | | | |
| | | | UE, change of | | | |
| | | | serving cell and | | | |
| | | | area of interest, | | | |
| | | | stop change of | | | |
| | | | serving cell and | | | |
| | | | area of | | | |
| | | | interest, . . . ) | | | |
| Report Area | M | | ENUMERATED | | — | |
| | | | (cell, . . . ) | | | |
| Area of Interest List | | 0 . . . 1 | | | — | |
| >Area of Interest Item | | 1 . . . | | | — | |
| | | <maxnoofAoI> | | | | |
| >>Area of Interest | M | | 9.3.1.66 | | — | |
| >>Location | M | | 9.3.1.76 | | — | |
| Reporting Reference | | | | | | |
| ID | | | | | | |
| Location Reporting | C- | | Location | | — | |
| Reference ID to be | ifEventTypeisStopUEPresinAoI | | Reporting | | | |
| Cancelled | | | Reference ID | | | |
| | | | 9.3.1.76 | | | |
| Additional Location | O | | ENUMERATED | | YES | ignore |
| Information | | | (Include | | | |
| | | | PSCell, . . . ) | | | |

| Range bound | Explanation |
|---|---|
| maxnoofAoI | Maximum no. of areas of interest. Value is 64. |

| Condition | Explanation |
|---|---|
| ifEventTypeisStopUEPresinAoI | This IE shall be present if the Event Type IE is set to “stop UE presence in |
| | the area of interest” or “stop change of serving cell and area of interest”. |

### 9.4.5 Information Element Definitions

```
... ...
EventType ::= ENUMERATED {
  direct,
  change-of-serve-cell,
  ue-presence-in-area-of-interest,
  stop-change-of-serve-cell,
  stop-ue-presence-in-area-of-interest,
  cancel-location-reporting-for-the-ue,
  change-of-serve-cell-and-area-of-interest,
  stop-change-of-serve-cell-and-area-of-interest,
  ...
}
```

According to embodiments of the present disclosure, improved methods and improved apparatuses for configuring location reporting type may be provided.

Particularly, by including a plurality of location reporting request types in a message, AMF can configure multiple Location Reporting Request Types at the same time. Therefore, the efficiency may be improved.

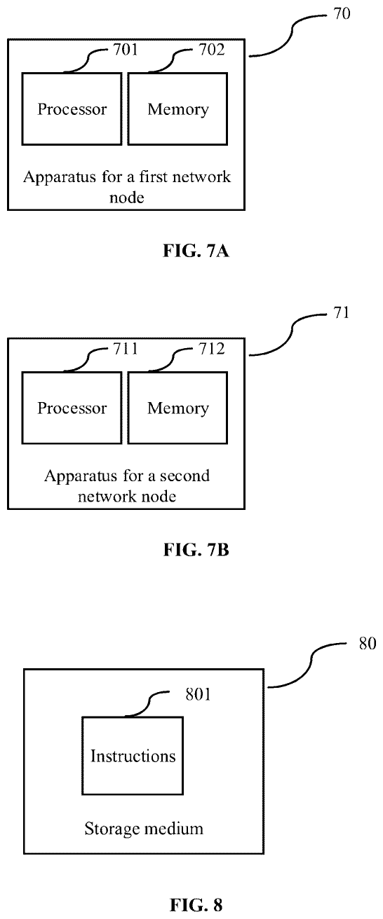

FIG. 7A is a block diagram showing an exemplary apparatus for a first network node, which is suitable for performing the method according to embodiments of the disclosure.

As shown in FIG. 7A, the apparatus 70 for the first network node comprises: a processor 701; and a memory 702. The memory 702 contains instructions executable by the processor 701. The apparatus 70 for the first network node is operative for: receiving from a second network node, a message indicating a plurality of location reporting request types; and reporting a location of a terminal device to the second network node, when a location reporting request type in the plurality of location reporting request types is satisfied.

In embodiments of the present disclosure, the apparatus 70 is further operative to perform the method according to any of the above embodiments, such as these shown in FIG. 2, 4A, 4B, 4C, 4D, 5A, 5B, 5C, 5D, 6.

FIG. 7B is a block diagram showing an exemplary apparatus for a second network node, which is suitable for performing the method according to embodiments of the disclosure.

As shown in FIG. 7B, the apparatus 71 for the second network node comprises: a processor 711; and a memory 712. The memory 712 contains instructions executable by the processor 711. The apparatus 71 for the second network node is operative for: transmitting to a first network node, a message indicating a plurality of location reporting request types. The message indicates the first network node to report a location of a terminal device to the second network node, when a location reporting request type in the plurality of location reporting request types is satisfied.

In embodiments of the present disclosure, the apparatus 70 is further operative to perform the method according to any of the above embodiments, such as these shown in FIG. 3, 4A, 4B, 4C, 4D, 5A, 5B, 5C, 5D, 6.

The processors 701, 711 may be any kind of processing component, such as one or more microprocessor or microcontrollers, as well as other digital hardware, which may include digital signal processors (DSPs), special-purpose digital logic, and the like. The memories 702, 712 may be any kind of storage component, such as read-only memory (ROM), random-access memory, cache memory, flash memory devices, optical storage devices, etc.

FIG. 8 is a block diagram showing an apparatus/computer readable storage medium, according to embodiments of the present disclosure.

As shown in FIG. 8, the computer-readable storage medium 80, or any other kind of product, storing instructions 801 which when executed by at least one processor, cause the at least one processor to perform the method according to any one of the above embodiments, such as these shown in FIG. 2, 3, 4A, 4B, 4C, 4D, 5A, 5B, 5C, 5D, 6.

In addition, the present disclosure may also provide a carrier containing the computer program as mentioned above, the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

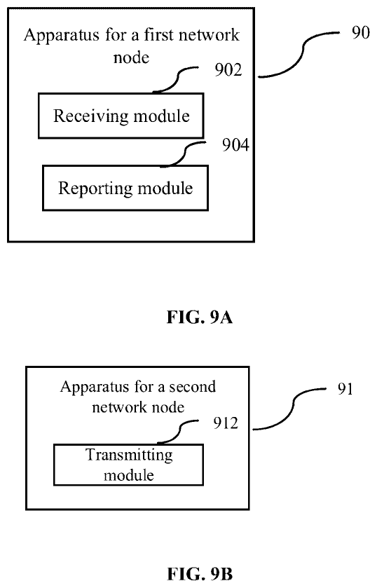

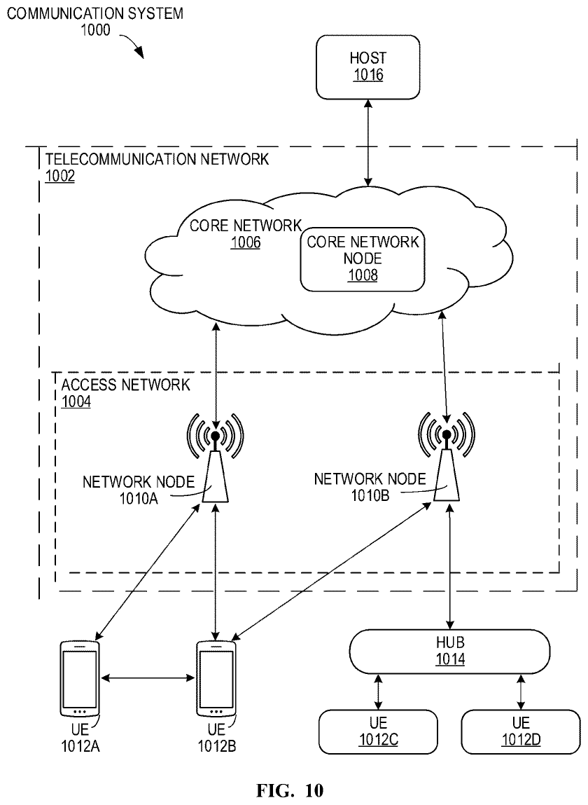

FIG. 9A is a block diagram showing modules for a first network node, which are suitable for performing the method according to embodiments of the disclosure.

As shown in FIG. 9A, the apparatus 90 for the first network node may comprise: a receiving module 902, configured to receive from a second network node, a message indicating a plurality of location reporting request types; and a reporting module 904, configured to report a location of a terminal device to the second network node, when a location reporting request type in the plurality of location reporting request types is satisfied.

In embodiments of the present disclosure, the apparatus 90 is further operative to perform the method according to any of the above embodiments, such as these shown in FIG. 2, 4A, 4B, 4C, 4D, 5A, 5B, 5C, 5D, 6.

FIG. 9B is a block diagram showing modules for a second network node, which are suitable for performing the method according to embodiments of the disclosure.

As shown in FIG. 9B, the apparatus 91 for the second network node may comprise: a transmitting module 912, configured to transmit to a first network node, a message indicating a plurality of location reporting request types. The message indicates the first network node to report a location of a terminal device to the second network node, when a location reporting request type in the plurality of location reporting request types is satisfied.

In embodiments of the present disclosure, the apparatus 91 is further operative to perform the method according to any of the above embodiments, such as these shown in FIG. 3, 4A, 4B, 4C, 4D, 5A, 5B, 5C, 5D, 6.

The term ‘module’ may have conventional meaning in the field of electronics, electrical devices and/or electronic devices and may include, for example, electrical and/or electronic circuitry, devices, units, processors, memories, logic solid state and/or discrete devices, computer programs or instructions for carrying out respective tasks, procedures, computations, outputs, and/or displaying functions, and so on, as such as those that are described herein.

With these modules, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

The first network node, the second network node may be any communication device, and/or computing device in a network, such as any function entity, server, personal computer, user equipment, router, gateway device, etc. Examples for the first network node, and/or the second network node may be illustrated as follows.

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

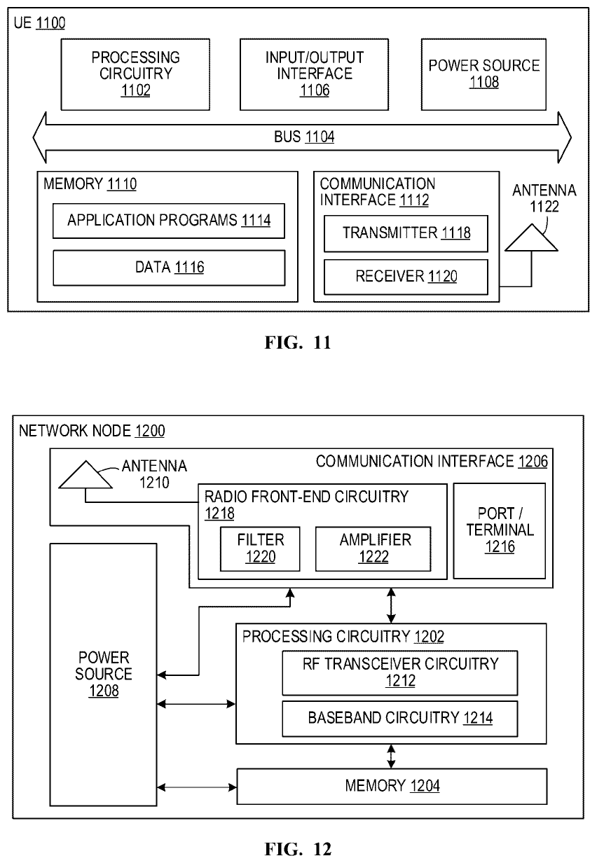

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

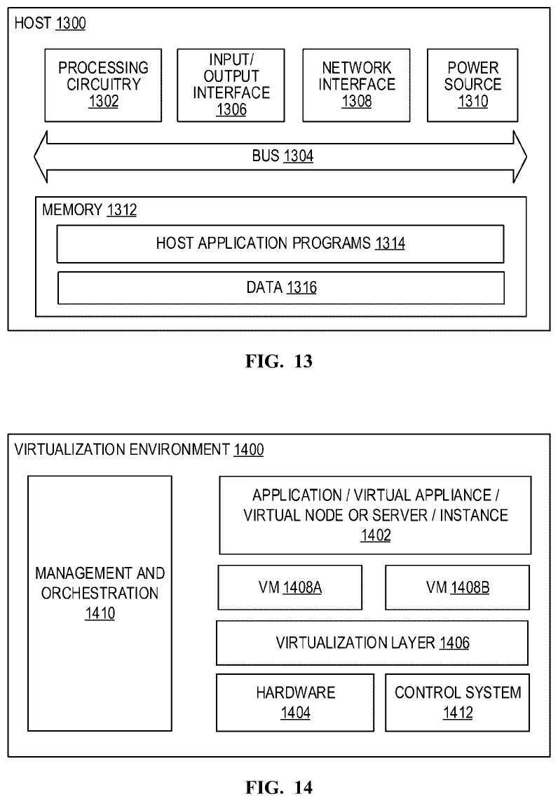

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

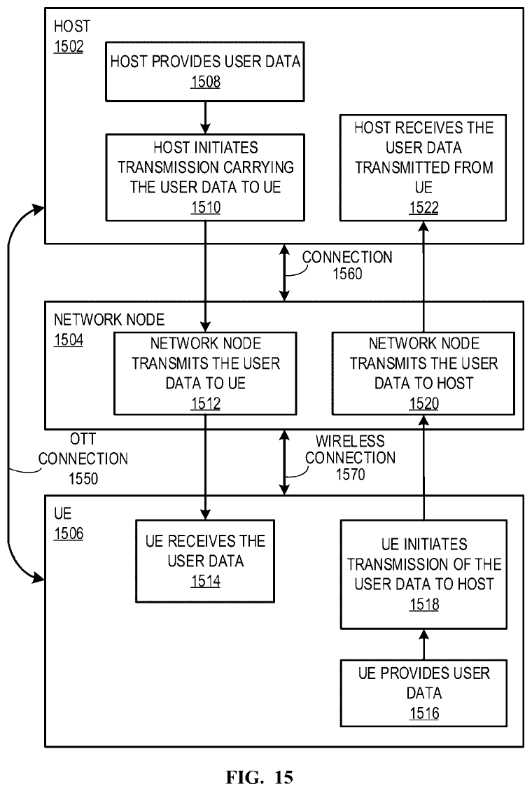

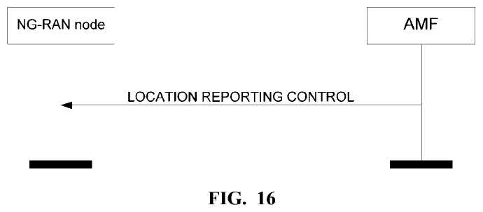

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. According to embodiments of the present disclosure, improved methods and improved apparatuses for configuring location reporting type may be provided. Particularly, by including a plurality of location reporting request types in a message, AMF can configure multiple Location Reporting Request Types at the same time. Therefore, the efficiency may be improved. More precisely, the teachings of these embodiments may improve the performance, e.g., data rate, latency, power consumption, of the communication network, and thereby provide benefits such as reduced user waiting time, relaxed restriction on file size, improved content resolution, better responsiveness, extended battery lifetime.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The followings are the references which are incorporated herein in their entirety:

3GPP TS38.413 v17.0.0, 3GPP TS38.413 v17.5.0

| ABBREVIATION | EXPLANATION |
|---|---|
| NGAP | next generation application protocol |
| AOI | area of interest |

### APPENDIX

According to embodiments of the present disclosure, a change request as following may be also provided to improve the current 3GPP standards.

1. A method performed by a first network node, comprising:
receiving, from a second network node, a message indicating a plurality of location reporting request types; and
reporting a location of a terminal device to the second network node, when a location reporting request type in the plurality of location reporting request types is satisfied.

2. The method according to claim 1,
wherein the message includes a first information element, IE, indicating a first location reporting request type, and a second IE indicating a second location reporting request type.

3. The method according to claim 2,
wherein the first location reporting request type is at least one of a change of serving cell and a UE presence in the area of interest; and
wherein the second location reporting request type is at least one of the UE presence in the area of interest and the change of serving cell.

4. The method according to claim 2,
wherein the first IE is a location reporting request type IE; and
wherein the second IE is an additional location reporting request type list.

5. The method according to claim 4,
wherein the second IE indicates one or more location reporting request types.

6. The method according to claim 1,
wherein the message includes a location reporting request type IE, including an enumerated value indicating a first location reporting request type and a second location reporting request type.

7. The method according to claim 6,
wherein the location reporting request type IE is configured with at least one of a first enumerated value indicating the first location reporting request type and the second location reporting request type; and a second enumerated value indicating a stop of the first location reporting request type and the second location reporting request type.

8. The method according to claim 1,
wherein the message is transmitted via a next generation application protocol, NGAP, interface.

9. The method according to claim 1,
wherein the message is at least one of:
a location reporting control message;
an initial context setup request message; and
a handover request message.

10. The method according to claim 1,
wherein the message is for triggering a location report when at least one of:
the terminal device is in a connected mode;
the terminal device is reconnected; and
a N2-based handover happens for the terminal device.

11. The method according to claim 1,
wherein the first network node is in a next generation-radio access network, NG-RAN; and
wherein the second network node is an access and mobility management function, AMF.

12. A method performed by a second network node, comprising:
transmitting; to a first network node, a message indicating a plurality of location reporting request types;
wherein the message indicates the first network node to report a location of a terminal device to the second network node, when a location reporting request type in the plurality of location reporting request types is satisfied.

13-22. (canceled)

23. An apparatus for a first network node, comprising:
a processor; and
a memory, the memory containing instructions executable by the processor, whereby the apparatus for the first network node is operative for:
receiving, from a second network node, a message indicating a plurality of location reporting request types; and
reporting a location of a terminal device to the second network node, when a location reporting request type in the plurality of location reporting request types is satisfied.

24-27. (canceled)
